(19) United States
(12) Patent Application Publication
(10) Pub. No.: US 2014/0042130 A1
(43) Pub. Date: Feb. 13, 2014

(54) Plasma Treatment of Substrates

(71) Applicants: Pierre Descamps, Rixensart (BE); Thomas Gaudy, Montescot (FR); Vincent Kaiser, Pipaix (BE); Patrick Leempoel, Bruxelles (BE); Francoise Massines, Sorede (FR)

(72) Inventors: Pierre Descamps, Rixensart (BE); Thomas Gaudy, Montescot (FR); Vincent Kaiser, Pipaix (BE); Patrick Leempoel, Bruxelles (BE); Francoise Massines, Sorede (FR)

(21) Appl. No.: 14/112,085

(22) PCT Filed: Apr. 16, 2012
(86) PCT No.: PCT/EP12/01628

§ 371 Date: Oct. 16, 2013

(30) Foreign Application Priority Data
Apr. 27, 2011 (EP) 11305495.1

(51) Int. Cl. H05H 1/24

(52) U.S. Cl. CPC H05H 1/2406
USPC 219/121.5

(57) ABSTRACT

A process for plasma treating a substrate comprises applying a radio frequency high voltage to at least one electrode positioned within a dielectric housing having an inlet and an outlet while causing a process gas, usually comprising helium, to flow from the inlet past the electrode to the outlet, thereby generating a non-equilibrium atmospheric pressure plasma. An atomised or gaseous surface treatment agent is incorporated in the non-equilibrium atmospheric pressure plasma. The substrate is positioned adjacent to the plasma outlet so that the surface is in contact with the plasma and is moved relative to the plasma outlet. The velocity of the process gas flowing past the electrode is less than 100 m/s. Process gas is also injected into the dielectric housing at a velocity greater than 100 m/s. The volume ratio of process gas injected at a velocity greater than 100 m/s to process gas flowing past the electrode at less than 100 m/s is from 1:20 to 5:1.

The present invention relates to treating a substrate using a plasma system. In particular it relates to the deposition of a thin film on a substrate from a non-equilibrium atmospheric pressure plasma incorporating an atomised surface treatment agent.

When matter is continually supplied with energy, its temperature increases and it typically transforms from a solid to a liquid and, then, to a gaseous state. Continuing to supply energy causes the system to undergo yet a further change of state in which neutral atoms or molecules of the gas are broken up by energetic collisions to produce negatively charged electrons, positive or negatively charged ions and other excited species. This mix of charged and other excited particles exhibiting collective behaviour is called “plasma”, the fourth state of matter. Due to their electrical charge, plasmas are highly influenced by external electromagnetic fields, which make them readily controllable. Furthermore, their high energy content allows them to achieve processes which are impossible or difficult through the other states of matter, such as by liquid or gas processing.

The term “plasma” covers a wide range of systems whose density and temperature vary by many orders of magnitude. Some plasmas are very hot and all their microscopic species (ions, electrons, etc.) are in approximate thermal equilibrium, the energy input into the system being widely distributed through atomic/molecular level collisions. Other plasmas, however, have their constituent species at widely different temperatures and are called “non-thermal equilibrium” plasmas. In these non-thermal plasmas the free electrons are very hot with temperatures of many thousands of Kelvin (K) whilst the neutral and ionic species remain cool. Because the free electrons have almost negligible mass, the total system heat content is low and the plasma operates close to room temperature thus allowing the processing of temperature sensitive materials, such as plastics or polymers, without imposing a damaging thermal burden onto the sample. However, the hot electrons create, through high energy collisions, a rich source of radicals and excited species with a high chemical potential energy capable of profound chemical and physical reactivity. It is this combination of low temperature operation plus high reactivity which makes non-thermal plasma technologically important and a very powerful tool for manufacturing and material processing, capable of achieving processes which, if achievable at all without plasma, would require very high temperatures or noxious and aggressive chemicals.

For industrial applications of plasma technology, a convenient method is to couple electromagnetic power into a volume of process gas. A process gas may be a single gas or a mixture of gases and vapours which is excitable to a plasma state by the application of the electromagnetic power. Workpieces/samples are treated by the plasma generated by being immersed or passed through the plasma itself or charged and/or excited species derived therefrom because the process gas becomes ionised and excited, generating species including chemical radicals, and ions as well as UV-radiation, which can react or interact with the surface of the workpieces/samples. By correct selection of process gas composition, driving power frequency, power coupling mode, pressure and other control parameters, the plasma process can be tailored to the specific application required by a manufacturer.

Because of the huge chemical and thermal range of plasmas, they are suitable for many technological applications. Non-thermal equilibrium plasmas are particularly effective for surface activation, surface cleaning, material etching and coating of surfaces.

Since the 1960s the microelectronics industry has developed the low pressure Glow Discharge plasma into an ultra-high technology and high capital cost engineering tool for semiconductor, metal and dielectric processing. The same low pressure Glow Discharge type plasma has increasingly penetrated other industrial sectors since the 1980s offering polymer surface activation for increased adhesion/bond strength, high quality degreasing/cleaning and the deposition of high performance coatings. Glow discharges can be achieved at both vacuum and atmospheric pressures. In the case of atmospheric pressure glow discharge, gases such as helium, argon or nitrogen are utilised as diluents and a high frequency (e.g. >1 kHz) power supply is used to generate a homogeneous glow discharge at atmospheric pressure, with Penning ionisation mechanism being possibly dominant in He/N2 mixtures with respect to primary ionisation by electrons, (see for example, Kanazawa et al, J. Phys. D: Appl. Phys. 1988, 21, 838, Okazaki et al, Proc. Jpn. Symp. Plasma Chem. 1989, 2, 95, Kanazawa et al, Nuclear Instruments and Methods in Physical Research 1989, B37/38, 842, and Yokoyama et al., J. Phys. D: Appl. Phys. 1990, 23, 374).

A variety of “plasma jet” systems have been developed, as means of atmospheric pressure plasma treatment. Plasma jet systems generally consist of a gas stream which is directed between two electrodes. As power is applied between the electrodes, a plasma is formed and this produces a mixture of ions, radicals and active species which can be used to treat various substrates. The plasma produced by a plasma jet system is directed from the space between the electrodes (the plasma zone) as a flame-like phenomenon and can be used to treat remote objects.

U.S. Pat. Nos. 5,198,724 and 5,369,336 describe “cold” or non-thermal equilibrium atmospheric pressure plasma jet (hereafter referred to as APPJ), which consisted of an RF powered metal needle acting as a cathode, surrounded by an outer cylindrical anode. U.S. Pat. No. 6,429,400 describes a system for generating a blown atmospheric pressure glow discharge (APGD). This comprises a central electrode separated from an outer electrode by an electrical insulator tube. The inventor claims that the design does not generate the high temperatures associated with the prior art. Kang et al (Surf Coat. Technol., 2002, 171, 141-148) have also described a 13.56 MHz RF plasma source that operates by feeding helium or argon gas through two coaxial electrodes. In order to prevent an arc discharge, a dielectric material is loaded outside the central electrode. WO94/14303 describes a device in which an electrode cylinder has a pointed portion at the exit to enhance plasma jet formation.

U.S. Pat. No. 5,837,958 describes an APPJ based on coaxial metal electrodes where a powered central electrode and a dielectric coated ground electrode are utilised. A portion of the ground electrode is left exposed to form a bare ring electrode near the gas exit. The gas flow (air or argon) enters through the top and is directed to form a vortex, which keeps the arc confined and focused to form a plasma jet. To cover a wide area, a number of jets can be combined to increase the coverage.

U.S. Pat. No. 6,465,964 describes an alternative system for generating an APPJ, in which a pair of electrodes is placed around a cylindrical tube. Process gas enters through the top of the tube and exits through the bottom. When an AC electric field is supplied between the two electrodes, a plasma is generated by passing a process gas therebetween within the tube and this gives rise to an APPJ at the exit. The position of the electrodes ensures that the electric field forms in the axial direction. In order to extend this technology to the coverage of wide area substrates, the design can be modified, such that the central tube and electrodes are redesigned to have a rectangular tubular shape. This gives rise to a wide area plasma, which can be used to treat large substrates such as reel-to-reel plastic film.

U.S. Pat. No. 5,798,146 describes formation of plasma using a single sharp needle electrode placed inside a tube and applying a high voltage to the electrode produces a leakage of electrons, which further react with the gas surrounding the electrode, to produce a flow or ions and radicals. As there is no second electrode, this does not result in the formation of an arc. Instead, a low temperature plasma is formed which is carried out of the discharge space by a flow of gas. Various nozzle heads have been developed to focus or spread the plasma. The system may be used to activate, clean or etch various substrates. Stoffels et al (Plasma Sources Sci. Technol., 2002, 11, 383-388) have developed a similar system for biomedical uses.

WO 02/028548 describes a method for forming a coating on a substrate by introducing an atomized liquid and/or solid coating material into an atmospheric pressure plasma discharge or an ionized gas stream resulting therefrom. WO 02/098962 describes coating a low surface energy substrate by exposing the substrate to a silicon compound in liquid or gaseous form and subsequently post-treating by oxidation or reduction using a plasma or corona treatment, in particular a pulsed atmospheric pressure glow discharge or dielectric barrier discharge.

WO 03/097245 and WO 03/101621 describe applying an atomised coating material onto a substrate to form a coating. The atomised coating material, upon leaving an atomizer such as an ultrasonic nozzle or a nebuliser, passes through an excited medium (plasma) to the substrate. The substrate is positioned remotely from the excited medium. The plasma is generated in a pulsed manner.

WO2006/048649 describes generating a non-equilibrium atmospheric pressure plasma incorporating an atomised surface treatment agent by applying a radio frequency high voltage to at least one electrode positioned within a dielectric housing having an inlet and an outlet while causing a process gas to flow from the inlet past the electrode to the outlet. The electrode is combined with an atomiser for the surface treatment agent within the housing. The non-equilibrium atmospheric pressure plasma extends from the electrode at least to the outlet of the housing so that a substrate placed adjacent to the outlet is in contact with the plasma, and usually extends beyond the outlet. WO2006/048650 teaches that the flame-like non-equilibrium plasma discharge, sometimes called a plasma jet, could be stabilized over considerable distances by confining it to a long length of tubing. This prevents air mixing and minimises quenching of the flame-like non-equilibrium plasma discharge. The flame-like non-equilibrium plasma discharge extends at least to the outlet, and usually beyond the outlet, of the tubing.

WO03/085693 describes an atmospheric plasma generation assembly having a reactive agent introducing means, a process gas introducing means and one or more multiple parallel electrode arrangements adapted for generating a plasma. The assembly is adapted so that the only means of exit for a process gas and atomised liquid or solid reactive agent introduced into said assembly is through the plasma region between the electrodes. The assembly is adapted to move relative to a substrate substantially adjacent to the electrodes outermost tips. Turbulence may be generated in the plasma generation assembly to ensure an even distribution of the atomised spray, for example by introducing process gas perpendicular to the axis of the body such that turbulence is generated close to the ultrasonic spray nozzle outlet as the gas flow reorientates to the main direction of flow along the length of the axis. Alternatively turbulence can be induced by positioning a restrictive flow disc in the process gas flow field just upstream of the ultrasonic spray nozzle tip.

The paper “Generation of long laminar plasma jets at atmospheric pressure and effects of flow turbulence” by Wenxia Pan et al in ‘Plasma Chemistry and Plasma Processing’, Vol. 21, No. 1, 2001 shows that laminar flow plasma with very low initial turbulent kinetic energy will produce a long jet with low axial temperature gradient and suggests that this kind of long laminar plasma jet could greatly improve the controllability for materials processing, compared with a short turbulent arc jet.

The paper “Analysis of mass transport in an atmospheric pressure remote plasma enhanced chemical vapor deposition process” by R. P. Cardoso et al in ‘Journal of Applied Physics’ Vol. 107, 024909 (2010) shows that in remote microwave plasma enhanced chemical vapor deposition processes operated at atmospheric pressure, high deposition rates are associated with the localization of precursors on the treated surface, and that mass transport can be advantageously ensured by convection for the heavier precursor, the lighter being driven by turbulent diffusion toward the surface.

The paper “Plasma Polymerisation of HMDSO with an Atmospheric Plasma Jet for Corrosion Protection of Aluminium and Low-Adhesion Surfaces” by U. Lommatzsch et al in ‘Plasma Processes and Polymers’ 2009, 6, 642-648 describes deposition of thin functional films on aluminium with an atmospheric pressure plasma jet using hexamethyldisiloxane as precursor. The paper “Deposition of silicon dioxide films with an atmospheric-pressure plasma jet” by S. E. Babayan et al in ‘Plasma Sources Sci. Technol’ 1998, 7, 286-288 describes a plasma jet which operates by feeding oxygen and helium gas between two coaxial electrodes driven by a 13.56 MHz RF source and which deposits silica films from tetraethoxysilane precursor. The paper “Influence of atmospheric plasma source and gas composition on the properties of deposited siloxane coatings” by D. P. Dowling et al in ‘Plasma Processes and Polymers’ 2009, 6, 483-489 describes deposition of siloxane coatings from tetraethoxysilane precursor using two different atmospheric plasma systems, namely a reel-to-reel atmospheric plasma liquid deposition system and an atmospheric plasma jet system.

The use of atmospheric plasma technologies for thin film deposition offers a lot of benefits versus alternative low pressure plasma deposition in terms of capital cost (no need for vacuum chamber or vacuum pumps) or maintenance. This is particularly true for a jet-like system that allows precise deposition on the substrate. The plasma jet technology of WO2006/048649 and WO2006/048650 has been used successfully to deposit many surface treatment agents as a thin film on a substrate. One problem which has been encountered when the surface treatment agent is a polymerisable precursor is the polymerization of precursor within the plasma zone leading to the deposition of powdery material and formation of a coating film of low density.

WO2009/034012 describes a process for coating a surface, in which an atomized surface treatment agent is incorporated in a non-equilibrium atmospheric pressure plasma generated in a noble process gas or an excited and/or ionised gas stream resulting therefrom, and the surface to be treated is positioned to receive atomized surface treatment agent which has been incorporated therein, is characterized in that the particle content of the coating formed on the surface is reduced by incorporating a minor proportion of nitrogen in the process gas. However the addition of nitrogen is detrimental to the energy available for precursor dissociation.

In a process according to the present invention for plasma treating a substrate (25) by applying a radio frequency high voltage to at least one electrode (11, 12) positioned within a dielectric housing (14) having an inlet and an outlet while causing a process gas to flow from the inlet past the electrode to the outlet, thereby generating a non-equilibrium atmospheric pressure plasma, incorporating an atomised or gaseous surface treatment agent in the non-equilibrium atmospheric pressure plasma, and positioning the substrate adjacent to the outlet (15) of the dielectric housing (14) so that the surface of the substrate is in contact with the plasma and is moved relative to the outlet of the dielectric housing, the velocity of the process gas flowing past the electrode is less than 100 m/s, and process gas is also injected into the dielectric housing at a velocity greater than 100 m/s, the ratio of process gas flows injected at a velocity greater than 100 m/s to process gas flowing past the electrode at less than 100 m/s being from 1:20 to 5:1.

The gas velocity is the average velocity. In laminar regime, the fluid velocity of a gas flowing through a pipe or channel has a parabolic profile, but where a value for gas velocity is stated in this application, it is the average velocity, which corresponds to the ratio between the total flow divided by the area of the channel.

The process gas flow from the inlet past the electrode preferably comprises helium, although another inert gas such as argon or nitrogen can be used. The process gas generally comprises at least 50% by volume helium, and preferably comprises at least 90% by volume, more preferably at least 95%, helium, optionally with up to 5 or 10% of another gas, for example argon, nitrogen or oxygen. A higher proportion of an active gas such as oxygen can be used if it is required to react with the surface treatment agent. The process gas injected at a velocity greater than 100 m/s also generally comprises at least 50% by volume helium, and preferably comprises at least 90% by volume, more preferably at least 95%, helium. Preferably the process gas injected at a velocity greater than 100 m/s has the same composition as the process gas flowing past the electrode; most preferably both inputs of process gas are of helium.

The dielectric housing defines a ‘plasma tube’ within which the non-equilibrium atmospheric pressure plasma is formed. We have found that when using helium as process gas, a plasma jet can stay in laminar flow regime unless steps are taken to change the gas flow regime. When a heavier gas such as argon having a lower kinematic viscosity than helium (kinematic viscosity v is the ratio between the dynamic viscosity and the density of the gas) is used as process gas, the Reynolds number defined as Re=VD/v is larger (V is the fluid velocity and D is the hydraulic diameter of the channel). In the case of argon, the gas flow generally becomes turbulent beyond a centimetre or two into the plasma tube. A laminar flow regime has disadvantages when applying a surface treatment agent to a substrate. The directional jets may lead to patterning of the deposition and/or to formation of streamers. A turbulent flow regime gives a more diffuse and more uniform plasma. Controlling the ratio of helium process gas injected at a velocity greater than 100 m/s to helium process gas flowing past the electrode at less than 100 m/s promotes the creation of a turbulent gas flow regime within the plasma tube. By creating a turbulent helium gas flow regime within the plasma tube a more uniform non-equilibrium atmospheric pressure plasma is achieved, leading to a better and more uniform deposition on the substrate of a film derived from the surface treatment agent. Controlling the ratio of helium process gas injected at a velocity greater than 100 m/s to helium process gas flowing past the electrode at less than 100 m/s can also increase the deposition rate of a film on the substrate while decreasing the total flow of process gas through the dielectric housing. This is an advantage because the large consumption of process gas, and resulting cost of process gas such as helium, is a major issue relating to atmospheric plasma deposition technologies.

The plasma can in general be any type of non-equilibrium atmospheric pressure plasma or corona discharge. Examples of non-equilibrium atmospheric pressure plasma discharge include dielectric barrier discharge and diffuse dielectric barrier discharge such as glow discharge plasma. A diffuse dielectric barrier discharge e.g. a glow discharge plasma is preferred. Preferred processes are “low temperature” plasmas wherein the term “low temperature” is intended to mean below 200° C., and preferably below 100° C.

The invention will be described with reference to the accompanying drawings, of which

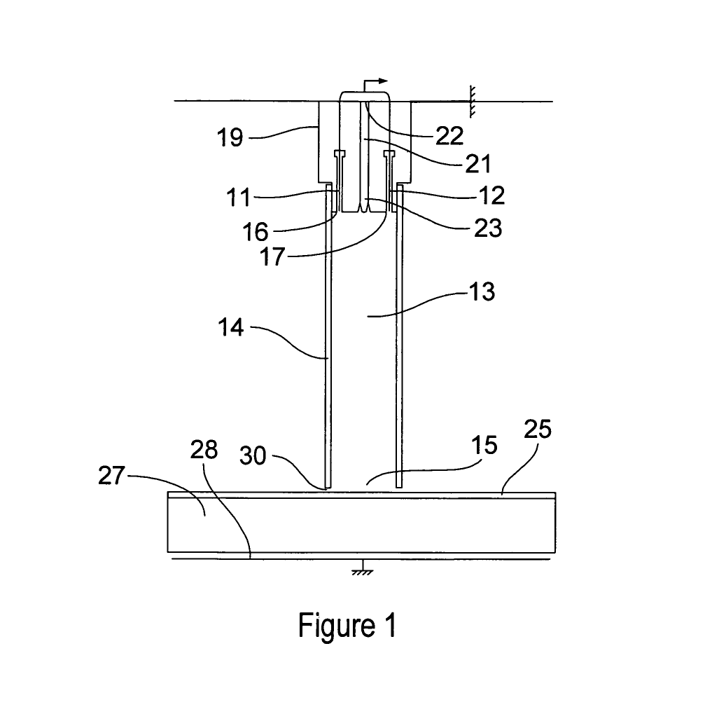

FIG. 1 is a diagrammatic cross section of an apparatus according to the invention for generating a non-equilibrium atmospheric pressure plasma incorporating an atomised surface treatment agent:

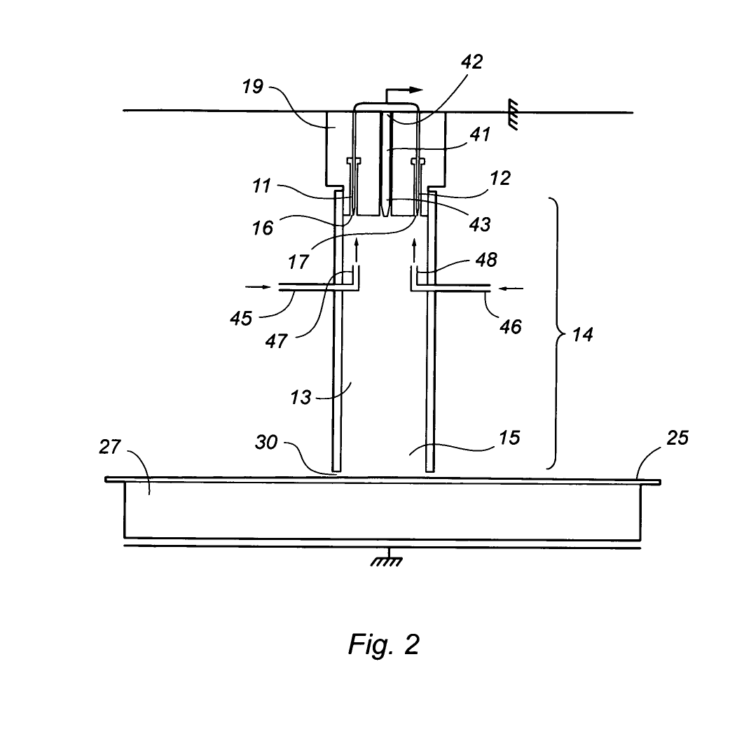

FIG. 2 is a diagrammatic cross section of an alternative apparatus according to the invention for generating a non-equilibrium atmospheric pressure plasma incorporating a gaseous surface treatment agent.

The apparatus of FIG. 1 comprises two electrodes (11, 12) positioned within a plasma tube (13) defined by a dielectric housing (14) and having an outlet (15). The electrodes (11, 12) are needle electrodes both having the same polarity and are connected to a suitable radio frequency (RF) power supply. The electrodes (11, 12) are each positioned within a narrow channel (16 and 17 respectively), for example 0.1 to 5 mm wider than the electrode, preferably 0.2 to 2 mm wider than the electrode, communicating with plasma tube (13). Helium process gas is fed to a chamber (19) whose outlets are the channels (16, 17) surrounding the electrodes. The chamber (19) is made of a heat resistant, electrically insulating material which is fixed in an opening in the base of a metal box. The metal box is grounded but grounding of this box is optional. The chamber (19) can alternatively be made of an electrically conductive material, provided that all the electrical connections are insulated from the ground, and any part in potential contact with the plasma is covered by a dielectric. The helium process gas entering chamber (19) is constrained to flow through the two narrow channels (16, 17) past the electrodes (11, 12). The channels (16, 17) form the inlet to dielectric housing (14) for the helium process gas which flows past the electrode at a velocity of less than 100 m/s. The rate of feed of helium to chamber (19), relative to the cross-sectional area of channels (16, 17), is adjusted so that the velocity of the process gas which flows past the electrode is less than 100 m/s.

An atomiser (21) having an inlet (22) for surface treatment agent is situated adjacent to the electrode channels (16, 17) and has atomising means (not shown) and an outlet (23) feeding atomised surface treatment agent to the plasma tube (13). The chamber (19) holds the atomiser (21) and needle electrodes (11, 12) in place. The atomiser preferably uses the helium process gas used for generating the plasma as the atomizing gas to atomise the surface treatment agent. The atomiser forms the inlet for the process gas injected at a velocity greater than 100 m/s.

The dielectric housing (14) can be made of any dielectric material. Experiments described below were carried out using quartz dielectric housing (14) but other dielectrics, for example glass or ceramic or a plastic material such as polyamide, polypropylene or polytetrafluoroethylene, for example that sold under the trade mark ‘Teflon’, can be used. The dielectric housing (14) can be formed of a composite material, for example a fiber reinforced plastic designed for high temperature resistance.

The substrate (25) to be treated is positioned at the plasma tube outlet (15). The substrate (25) is laid on a dielectric support (27). The substrate (25) is arranged to be movable relative to the plasma tube outlet (15). The dielectric support (27) can for example be a dielectric layer (27) covering a metal supporting plate (28). The dielectric layer (27) is optional. The metal plate (28) as shown is grounded but grounding of this plate is optional. If the metal plate (28) is not grounded, this may contribute to the reduction of arcing onto a conductive substrate, for example a silicon wafer. The gap (30) between the outlet end of the dielectric housing (14) and the substrate (25) is the only outlet for the process gas fed to the plasma tube (13).

The electrodes (11, 12) are sharp surfaced and are preferably needle electrodes. The use of a metal electrode with a sharp point facilitates plasma formation. As an electric potential is applied to the electrode, an electric field is generated which accelerates charged particles in the helium process gas forming a plasma. The sharp point aids the process, as the electric field density is inversely proportional to the radius of curvature of the electrode. Needle electrodes thus possess the benefit of creating a gas breakdown using a lower voltage source because of the enhanced electric field at the sharp extremity of the needles.

When power is applied, local electric fields form around the electrode. These interact with the gas surrounding the electrode and a plasma is formed. The plasma generating apparatus can thus operate without special provision of a counter electrode. Alternatively a grounded counter electrode may be positioned at any location along the axis of the plasma tube.

The power supply to the electrode or electrodes (11, 12) is a radio frequency power supply as known for plasma generation, that is in the range 1 kHz to 300 kHz. Our most preferred range is the very low frequency (VLF) 3 kHz-30 kHz band, although the low frequency (LF) 30 kHz-300 kHz range can also be used successfully. The root mean square potential of the power supplied is generally in the range 1 kV to 100 kV, preferably between 4 kV and 30 kV. One suitable power supply is the Haiden Laboratories Inc. PHF-2K unit which is a bipolar pulse wave, high frequency and high voltage generator. It has a faster rise and fall time (<3 μs) than conventional sine wave high frequency power supplies. Therefore, it offers better ion generation and greater process efficiency. The frequency of the unit is also variable (1-100 kHz) to match the plasma system. An alternative suitable power supply is an electronic ozone transformer such as that sold under the reference ETI110101 by the company Plasma Technics Inc. It works at fixed frequency and delivers a maximum power of 100 Watt.

The surface treatment agent which is fed to the atomiser (21) can for example be a polymerisable precursor. When a polymerisable precursor is introduced into the plasma a controlled plasma polymerisation reaction occurs which results in the deposition of a polymer on any substrate which is placed adjacent to the plasma outlet. The precursor can be polymerised to a chemically inert material; for example an organosilicon precursor can be polymerised to a purely inorganic surface coating. Alternatively, a range of functional coatings have been deposited onto numerous substrates. These coatings are grafted to the substrate and retain the functional chemistry of the precursor molecule.

The atomiser (21) can for example be a pneumatic nebuliser, particularly a parallel path nebuliser such as that sold by Burgener Research Inc. of Mississauga, Ontario, Canada, under the trade mark An Mist HP, or that described in U.S. Pat. No. 6,634,572. The velocity of the gas carrying atomised material at the exit (23) of such a pneumatic nebuliser is typically 200 to 1000 m/s, usually 400 to 800 m/s. If helium is fed to a pneumatic nebuliser as the atomising gas, a pneumatic nebuliser is a convenient apparatus for injecting helium process gas at a velocity greater than 100 m/s.

While it is preferred that the atomiser (21) is mounted within the housing (14), an external atomiser can be used. This can for example feed process gas at a velocity greater than 100 m/s carrying atomised surface treatment agent to an inlet tube having an outlet in similar position to outlet (23) of nebuliser (21).

The apparatus of FIG. 2 comprises two electrodes (11, 12) each positioned within a narrow channel (16 and 17 respectively) communicating with plasma tube (13) defined by a dielectric housing (14) and having an outlet (15), all as described above for FIG. 1. Helium process gas is fed to a chamber (19) whose outlets are the channels (16, 17) surrounding the electrodes. The substrate (25) to be treated is positioned at the plasma tube outlet (15) with a narrow gap (30) between the outlet end of the dielectric housing (14) and the substrate (25). The substrate (25) is laid on a dielectric support (27) and is arranged to be movable relative to the plasma tube outlet (15), as described with reference to FIG. 1.

The apparatus of FIG. 2 comprises an atomiser (41) having an inlet (42) for surface treatment agent, atomising means (not shown) and an outlet (43) feeding atomised surface treatment agent to the plasma tube (13). The atomiser (41) does not use gas to atomise the surface treatment agent.

The apparatus of FIG. 2 further comprises injection tubes (45, 46) for injecting helium process gas at a velocity of above 100 m/s. The outlets (47, 48) of the injection tubes (45, 46) are directed towards the electrodes (11, 12) so that the direction of flow of the high velocity process gas from injection tubes (45, 46) is counter to the direction of flow of process gas through channels (16, 17) surrounding the electrodes.

The atomiser (41) can for example be an ultrasonic atomizer in which a pump is used to transport the liquid surface treatment agent into an ultrasonic nozzle and subsequently it forms a liquid film onto an atomising surface. Ultrasonic sound waves cause standing waves to be formed in the liquid film, which result in droplets being formed. The atomiser preferably produces drop sizes of from 10 to 100 μm, more preferably from 10 to 50 μm. Suitable atomisers for use in the present invention include ultrasonic nozzles from Sono-Tek Corporation, Milton, N.Y., USA. Alternative atomisers may include for example electrospray techniques, methods of generating a very fine liquid aerosol through electrostatic charging. The most common electrospray apparatus employs a sharply pointed hollow metal tube, with liquid pumped through the tube. A high-voltage power supply is connected to the outlet of the tube. When the power supply is turned on and adjusted for the proper voltage, the liquid being pumped through the tube transforms into a fine continuous mist of droplets. Inkjet technology can also be used to generate liquid droplets without the need of a carrier gas, using thermal, piezoelectric, electrostatic and acoustic methods.

Alternatively the surface treatment agent, for example in a gaseous state, can be incorporated in the process gas fed to the plasma tube (13). The surface treatment agent in gaseous phase can be carried either in the process gas injected at a velocity greater than 100 m/s or in the process gas flowing past the electrode at less than 100 m/s. Thus the surface treatment agent can be carried in the high velocity helium passing through injection tubes (45, 46) or in the helium entering chamber (19).

When the electrodes (11, 12) of the apparatus of FIG. 1 or the apparatus of FIG. 2 are connected to a low RF oscillating source, a plasma is formed in the flow of helium process gas from each of the channels (16 and 17). The two plasma jets created by the flow of helium process gas through channels (16, 17) past electrodes (11, 12) enter the plasma tube (13) and generally extend to the outlet (15) of the plasma tube.

The plasma jets can stay in laminar flow regime when helium is used as process gas unless steps are taken to change the gas flow regime. Using helium process gas with no injection of process gas at a velocity of above 100 m/s, separate plasma jets may be seen extending from the electrodes (11, 12) to the substrate (25). These directional jets may lead to patterning of the deposition. Also, streamers may develop between the needle electrodes (11, 12) and the substrate (25) or grounded electrode if used. Streamers can be responsible for powder formation in the plasma by premature reaction of the surface treatment agent because of the high energy concentration in the streamer. When depositing on a conductive substrate such as a conductive wafer, streamers are even more difficult to avoid because of the charge spreading at the surface of the conductor.

According to the present invention powder formation in the plasma is inhibited by creating a turbulent gas flow regime within the plasma tube (13). We have found that to encourage a turbulent gas flow regime within the plasma tube (13) the gap (30) at the outlet (15) of plasma tube (13), that is the gap between the dielectric housing (14) and the substrate (25), is preferably small. The gap (30) is preferably less than 1.5 mm., more preferably below 1 mm., and most preferably below 0.75 mm., for example 0.25 to 0.75 mm. The surface area of the gap (30) is preferably less than 35 times, more preferably less than 25 times or less than 20 times, the sum of the areas of the inlets for helium process gas. In the apparatus of FIG. 1 the surface area of the gap (30) is preferably less than 35 times the sum of the areas of the channels (16, 17) and of the nozzle of atomizer (21). In the apparatus of FIG. 2 the surface area of the gap (30) is preferably less than 25 times the sum of the areas of the channels (16, 17) and of the outlets (47, 48) of injection tubes (45, 46). More preferably the surface area of the gap (30) is less than 10 times the sum of the areas of the inlets for process gas, for example 2 to 10 times the sum of the areas of the inlets for process gas.

We have found that by controlling the ratio of helium process gas injected at a velocity greater than 100 m/s to helium process gas flowing past the electrode at less than 100 m/s according to the present invention it is possible to create a turbulent gas flow regime within the plasma tube (13) and to promote a gas flow circulation pattern in the plasma tube which improves the spatial distribution the plasma energy. If we would only use helium flowing through the channels to create a turbulent regime, increasing gas velocity in the plasma tube to reach the turbulent regime (and so increasing Reynolds number) would demand to increase helium gas flow through the channels. In consequence, the residence time of the helium in the channels and so in the high electric field regions would decrease, leading to a lower level of excitation of the helium. By using the helium process gas flow through the nebulizer (21) to create the turbulent regime, this regime can be obtained having a low helium process gas flow through the channels (16, 17) and so a high level of gas dissociation in the channels. If the amount of helium process gas injected at a velocity greater than 100 m/s, for example through a pneumatic nebuliser (21), is high enough relative to the helium process gas flowing through channels (16, 17) past the electrode (11, 12) at less than 100 m/s, the circulation of the gas flow leaving the nebulizer (21) confines the process gas leaving the channels (16, 17) to the vicinity of the tip of the needle electrodes (11, 12), where large electrical field is present. This increases the residence time of process gas in the large electrical field region. This results in a diffuse, more energetic helium plasma, as can be seen from the large amount of light emitted by the plasma, and hence a high deposition rate on the substrate of a film derived from the surface treatment agent. For a small helium gas flow through the channels (16, 17), the gas exits the channels with a low velocity. The recirculation of the helium gas coming out of the nebulizer (21) at high velocity influences the flow dynamic of the helium exiting the channels: gas recirculation confines the helium exiting the channels (16,17) in the vicinity of the needle tip.

The velocity of the helium process gas flowing past the electrode (11, 12) is preferably at least 3.5 m/s, more preferably at least 5 m/s and may for example be at least 10 m/s. The velocity of this helium process gas flowing past the electrode(s) can for example be up to 50 m/s, particularly up to 30 or 35 m/s.

The velocity of the helium process gas which is injected into the dielectric housing at a velocity greater than 100 m/s can for example be up to 1000 or 1500 m/s and is preferably at least 150 m/s, particularly at least 200 m/s, up to 800 m/s.

The flow rate of the helium process gas which has a velocity greater than 100 m/s, for example helium used as the atomising gas in a pneumatic nebuliser, is preferably at least 0.5 litres/minute and can be up to 2 or 2.5 l/m. The flow rate of the helium process gas flowing past the electrode (11, 12) is preferably at least 0.5 l/m and is preferably 3 l/m or below, more preferably 2 l/m or below. Although flow rates past the electrode (11, 12) of up to 5 l/m or even 10 l/m can be used successfully to form a non-equilibrium atmospheric pressure plasma and to deposit good films on a substrate, we have found that, surprisingly, the rate of deposition of a film on a substrate is lower when using a flow rate of the helium flowing past the electrode above 2 l/m and particularly when using a flow rate of the helium flowing past the electrode above 3 l/m. The gas flow ratio of helium injected at a velocity greater than 100 m/s to helium flowing past the electrode at less than 100 m/s is preferably at least 1:8 and optimum film deposition has been achieved with a ratio of helium flow injected at a velocity greater than 100 m/s to helium flowing past the electrode at less than 100 m/s of at least 1:4 or 1:3 up to a ratio of 2:1 or 3:1 or even 5:1. If the process gas flow through the channels (16, 17) past the electrodes increases with respect to the process gas flow injected at a velocity greater than 100 m/s through the nebulizer, the gas molecules coming out the channels possess a larger velocity and are less influenced by the gas recirculation in the tube. As a consequence, when helium process gas is used the flow regime in the plasma tube (13) is less turbulent and deposition efficiency decreases.

We have found that the best films and highest film deposition rate can be achieved according to the invention at total process gas flow rates of about 5 l/m or below. This is much less than has been reported in other plasma jet processes. The Lommatzsch et al paper in ‘Plasma Processes and Polymers’ 2009, 6, 642-648 describes process gas consumption in excess of 29 l/m. The Babayan et al paper in ‘Plasma Sources Sci. Technol’ 1998, 7, 286-288 describes a helium flow rate of over 40 l/m. The Dowling et al paper in ‘Plasma Processes and Polymers’ 2009, 6, 483-489 reports a helium usage of 10 l/m.

The surface treatment agent used in the present invention is a precursor material which is reactive within the non-equilibrium atmospheric pressure plasma or as part of a plasma enhanced chemical vapour deposition (PE-CVD) process and can be used to make any appropriate coating, including, for example, a material which can be used to grow a film or to chemically modify an existing surface. The present invention may be used to form many different types of coatings. The type of coating which is formed on a substrate is determined by the coating-forming material(s) used, and the process of the invention may be used to (co)polymerise coating-forming monomer material(s) onto a substrate surface.

The coating-forming material may be organic or inorganic, solid, liquid or gaseous, or mixtures thereof. Suitable inorganic coating-forming materials include metals and metal oxides, including colloidal metals. Organometallic compounds may also be suitable coating-forming materials, including metal alkoxides such as titanates, tin alkoxides, zirconates, alkoxides of germanium and erbium, alkoxides of aluminium, alkoxides of zinc or alkoxides of indium and/or tin. Particularly preferred silicon-containing precursors for depositing inorganic coatings such as polymerised SiOC films are tetraethyl orthosilicate Si(OC₂H₅)₄ and tetramethylcyclotetrasiloxane (CH₃(H)SiO)₄. Organic compounds of aluminium can be used to deposit alumina coatings on substrates, and a mixture of indium and tin alkoxides can be used to deposit a transparent conductive indium tin oxide coating film.

Tetraethyl orthosilicate is also suitable for depositing SiO₂ layers provided that oxygen is present in the process gas. Deposition of SiO₂ layers can easily be achieved via the addition of O₂ to the processing gas, for example 0.05 to 20% by volume O₂, particularly 0.5 to 10% O₂. Deposition of SiO₂ layers may also be possible without oxygen added in the process gas because of retro-diffusion of oxygen into the plasma tube.

The invention can alternatively be used to provide substrates with siloxane-based coatings using coating-forming compositions comprising silicon-containing materials. Suitable silicon-containing materials for use in the method of the present invention include silanes (for example, silane, alkylsilanes, alkylhalosilanes, alkoxysilanes), silazanes, polysilazanes and linear (for example, polydimethylsiloxane or polyhydrogenmethylsiloxane) and cyclic siloxanes (for example, octamethylcyclotetrasiloxane or tetramethylcyclotetrasiloxane), including organo-functional linear and cyclic siloxanes (for example, Si—H containing, halo-functional, and haloalkyl-functional linear and cyclic siloxanes, e.g. tetramethylcyclotetrasiloxane and tri(nonofluorobutyl)trimethylcyclotrisiloxane). A mixture of different silicon-containing materials may be used, for example to tailor the physical properties of the substrate coating for a specified need (e.g. thermal properties, optical properties, such as refractive index, and viscoelastic properties).

Suitable organic coating-forming materials include carboxylates, methacrylates, acrylates, styrenes, methacrylonitriles, alkenes and dienes, for example methyl methacrylate, ethyl methacrylate, propyl methacrylate, butyl methacrylate, and other alkyl methacrylates, and the corresponding acrylates, including organofunctional methacrylates and acrylates, including poly(ethyleneglycol) acrylates and methacrylates, glycidyl methacrylate, trimethoxysilyl propyl methacrylate, allyl methacrylate, hydroxyethyl methacrylate, hydroxypropyl methacrylate, dialkylaminoalkyl methacrylates, and fluoroalkyl (meth)acrylates, for example heptadecylfluorodecyl acrylate (HDFDA) of the formula

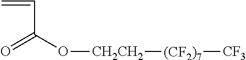

methacrylic acid, acrylic acid, fumaric acid and esters, itaconic acid (and esters), maleic anhydride, styrene, α-methylstyrene, halogenated alkenes, for example, vinyl halides, such as vinyl chlorides and vinyl fluorides, and fluorinated alkenes, for example perfluoroalkenes, acrylonitrile, methacrylonitrile, ethylene, propylene, allyl amine, vinylidene halides, butadienes, acrylamide, such as N-isopropylacrylamide, methacrylamide, epoxy compounds, for example glycidoxypropyltrimethoxysilane, glycidol, styrene oxide, butadiene monoxide, ethyleneglycol diglycidylether, glycidyl methacrylate, bisphenol A diglycidylether (and its oligomers), vinylcyclohexene oxide, conducting polymers such as pyrrole and thiophene and their derivatives, and phosphorus-containing compounds, for example dimethylallylphosphonate. The coating forming material may also comprise acryl-functional organosiloxanes and/or silanes.

The process of the invention is particularly suitable for coating electronic equipment including textile and fabric based electronics printed circuit boards, displays including flexible displays, and electronic components such as semiconductor wafers, resistors, diodes, capacitors, transistors, light emitting diodes (leds), organic leds, laser diodes, integrated circuits (ic), ic die, ic chips, memory devices logic devices, connectors, keyboards, semiconductor substrates, solar cells and fuel cells. Optical components such as lenses, contact lenses and other optical substrates may similarly be treated. Other applications include military, aerospace or transport equipment, for example gaskets, seals, profiles, hoses, electronic and diagnostic components, household articles including kitchen, bathroom and cookware, office furniture and laboratory ware.

The invention is illustrated by the following Examples

### EXAMPLES 1 to 4

The apparatus of FIG. 1 was used to deposit SiCO film on a conductive silicon wafer substrate. The dielectric housing (14) defining the plasma tube (13) was 18 mm in diameter. This housing (14) is made of quartz. The electrodes (11, 12) were each 1 mm diameter and were connected to the Plasma Technics ETI110101 unit operated at 20 kHz and maximum power of 100 watts. The channels (16,17) were each 2 mm in diameter, the electrodes (11, 12) being localized in the centre of each channel. The area of each channel free for gas flow around the needle is thus 2.35 mm². The atomiser (21) was the An Mist HP pneumatic nebuliser supplied by Burgener Inc. The area of the outlet of the atomiser (21) is less than 0.1 mm². The gap (30) between quartz housing (14) and the silicon wafer substrate was 0.75 mm; the area of the gap (30) was thus 42 mm². The surface area of the gap (30) was about 8.9 times the sum of the areas of the inlets for process gas.

Helium process gas was flowed through chamber (19) and thence through channels (16, 17) at 1 l/m, corresponding to a velocity of about 3.5 m/s. Tetramethyltetracyclosiloxane precursor was supplied to the atomiser (21) at 12 μl/m. Helium was fed to the atomiser (21) as atomising gas at the following rates:
Example 1—1.5 l/m; velocity 570 m/s, ratio of high velocity helium flow to low velocity helium flow 1.5:1
Example 2—1.2 l/m; velocity 460 m/s, ratio of high velocity helium flow to low velocity helium flow 1.2:1
Example 3—0.6 l/m; velocity 230 m/s, ratio of high velocity helium flow to low velocity helium flow 1:1.7
Example 4—0.4 l/m; velocity 150 m/s, ratio of high velocity helium flow to low velocity helium flow 1:2.5
   These flow rates are all sufficient to atomise the Tetramethyltetracyclosiloxaneprecursor and in all four Examples a smooth, low porosity SiCO film was deposited on the silicon wafer substrate. Each experiment was continued for 160 seconds (the substrate was not moved but plasma tube was moved over the 4″ wafer substrate). The thickness in Angstrom units of the film deposited is shown in Table 1

TABLE 1

| | Example 1 | Example 2 | Example 3 | Example 4 |
|---|---|---|---|---|
| Helium flow to | 1.5 | 1.2 | 0.6 | 0.4 |
| atomiser l/m | | | | |
| SiCO film | 3100 | 2800 | 1300 | 900 |
| thickness A | | | | |

It can be seen from Table 1 that an increase in helium process gas flow through the atomizer (21), over and above the gas needed to atomize the surface treatment agent, results in a much larger thickness of the film deposited. The film is deposited more rapidly and more economically at the higher ratios of high velocity helium flow to low velocity helium flow.

A clear change in discharge behavior could be seen as the helium process gas flow through the atomizer (21) was decreased. The plasma seen in Examples 1 and 2 was a diffuse, bright discharge at the top of the plasma tube. In Example 3 and particularly Example 4, the bright discharge extended linearly from the electrodes (11, 12) towards the outlet of tube (13), indicating that the helium leaving the channels (16, 17) is less affected by the helium flowing out of the nebulizer (21) and is subject to less turbulent flow.

### EXAMPLES 5 to 11

Using the apparatus shown in FIG. 1 and described in Example 1, experiments were carried out with a helium flow through the nebulizer (21) of 1.2 l/m, corresponding to a velocity of 460 m/s, and a Tetramethyltetracyclosiloxane flow of 12 μl/m. The helium process gas flow through chamber (19) and thence through channels (16, 17) was as follows:
Example 5—1.0 l/m; velocity 3.5 m/s, ratio of high velocity helium flow to low velocity helium flow 1.2:1
Example 6—1.5 l/m; velocity 5.3 m/s, ratio of high velocity helium flow to low velocity helium flow 1:1.25
Example 7—2.0 l/m; velocity 7.0 m/s, ratio of high velocity helium flow to low velocity helium flow 1:1.7
Example 8—2.5 l/m; velocity 8.8 m/s, ratio of high velocity helium flow to low velocity helium flow 1:2.1
Example 9—3.5 l/m; velocity 12.3 m/s, ratio of high velocity helium flow to low velocity helium flow 1:2.9
Example 10—5 l/m; velocity 18 m/s, ratio of high velocity helium flow to low velocity helium flow 1.4.2
Example 11—10 l/m; velocity 35 m/s, ratio of high velocity helium flow to low velocity helium flow 1.8.3
   Each experiment was continued for 160 seconds. The thickness in Angstrom units of the film deposited is shown in Table 2.

TABLE 2

| | Helium flow through | SiCO film |
|---|---|---|
| | channels l/m | thickness A |
| Example 5 | 1.0 | 3600 |
| Example 6 | 1.5 | 3100 |
| Example 7 | 2.0 | 3100 |
| Example 8 | 2.5 | 2200 |
| Example 9 | 3.5 | 2300 |
| Example 10 | 5 | 1100 |
| Example 11 | 10 | 1200 |

In all Examples a smooth, low porosity SiCO film was deposited on the silicon wafer substrate. Table 2 shows the surprising result that a much larger deposition rate is obtained using a lower helium flow through the channels (16, 17), that is a lower flow of low velocity helium. Larger deposition rates are achieved using a lower overall helium consumption. Particularly good deposition rates are achieved in Examples 5 to 9 where the ratio of high velocity process gas to low velocity process gas is in the range 1:3 to 1.2:1.

1. A process for plasma treating a substrate by applying a radio frequency high voltage to at least one electrode positioned within a dielectric housing having an inlet and an outlet while causing a process gas to flow from the inlet past the electrode to the outlet, thereby generating a non-equilibrium atmospheric pressure plasma, incorporating an atomised or gaseous surface treatment agent in the non-equilibrium atmospheric pressure plasma, and positioning the substrate adjacent to the outlet of the dielectric housing so that the surface of the substrate is in contact with the plasma and is moved relative to the outlet of the dielectric housing, characterised in that the velocity of the process gas flowing past the electrode is less than 100 m/s, and process gas is also injected into the dielectric housing at a velocity greater than 100 m/s, the volume ratio of process gas injected at a velocity greater than 100 m/s to process gas flowing past the electrode at less than 100 m/s being from 1:20 to 5:1.

2. The process of claim 1 wherein the process gas is helium.

3. The process of claim 2 wherein the volume ratio of helium injected at a velocity greater than 100 m/s to helium flowing past the electrode at less than 100 m/s is from 1:8 to 5:1.

4. The process of claim 1 wherein each electrode is a needle electrode.

5. The process of claim 4 wherein each electrode is surrounded by a channel through which the process gas flows at less than 100 m/s.

6. The process of claim 1 wherein the velocity of the process gas flowing past the electrode is from 3.5 to 35 m/s.

7. The process of claim 1 wherein the velocity of the process gas injected at a velocity greater than 100 m/s is from 100 to 1000 m/s.

8. The process of claim 1 wherein the surface treatment agent is injected into the non-equilibrium atmospheric pressure plasma within the dielectric housing through an atomiser wherein process gas is used to atomise the surface treatment agent, and the atomiser forms the inlet for the process gas injected at a velocity greater than 100 m/s.

9. The process of claim 8, wherein the radio frequency high voltage is applied to at least two electrodes positioned within the dielectric housing surrounding the atomiser and having the same polarity.

10. The process of claim 1 wherein the process gas injected at a velocity greater than 100 m/s is injected through at least one inlet directed towards the electrode.

11. The process of 10, wherein the surface treatment agent in gaseous phase is carried either in the process gas injected at a velocity greater than 100 m/s or in the process gas flowing past the electrode at less than 100 m/s.

12. The process of claim 1 wherein the surface area of the gap between the outlet of the dielectric housing and the substrate is less than 35 times the sum of the areas of the inlets for process gas.

13. The process of claim 1 wherein the gap between the outlet of the dielectric housing and the substrate is controlled to be less than 1 mm.
